(19) United States
(12) Patent Application Publication
(10) Pub. No.: US 2010/0287083 A1
(43) Pub. Date: Nov. 11, 2010

(54) Detecting modifications to financial terminals

(75) Inventor: Simon Blythe, Cambridgeshire (GB)

Correspondence Address: HOFFMANN & BARON, LLP, 6900 JERICHO TURNPIKE, SYOSSET, NY, 11791, US

(73) Assignee: MASTERCARD INTERNATIONAL, INC., Purchase, NY (US)

(21) Appl. No.: 11/965,946

(22) Filed: Dec. 28, 2007

(51) Int. Cl. G06Q 40/00

(52) U.S. Cl. 705/35

(57) ABSTRACT

A method of detecting unauthorized modifications of financial terminals includes receiving an electromagnetic profile from the terminal, comparing the received profile to a stored profile, and determining whether unauthorized modifications have been made based on the comparison. The determination may be based on a correlation coefficient and the method may include transmitting a stimulus profile in an active mode. A system for detecting unauthorized modifications to financial terminals includes a receiver to receive the emitted profile and a computing device. The computing device compares the received profile to the stored profile to determine whether unauthorized modifications have been made. The system may also include a transmitter to transmit a stimulus profile in an active mode, wherein the received profile is emitted by the financial terminal in response to the stimulus profile. The system may also be incorporated in the financial terminal.

### BACKGROUND OF THE INVENTION

1. Field of the Invention

The present invention generally relates to detecting unauthorized modifications to financial terminals, and more particularly to passive and active methods of detecting unauthorized modifications to financial terminals.

2. Brief Description of the Related Art

TEMPEST is an unclassified short name referring to investigations and studies of compromising emanations. Compromising emanations are unintentional intelligence-bearing signals that, if intercepted and analyzed, disclose classified information when transmitted, received, handled, or processed by information processing equipment. The details of many TEMPEST issues are classified and controlled under federal regulations.

Computers and other electronic equipment release interference to their surrounding environment. This can be shown by placing two video monitors together. The pictures will behave erratically until the terminals are spaced apart. Any electrical/electronic circuit that carries a time-varying current will emit electromagnetic signals with the strength of the emission proportional to the current amplitude and its time rate of change. These signals propagate from the source as free space and guided waves along conductors connected to or close to the radiating source. If time variations of the source currents are related in any way to the information content of the signals, which is generally true for data lines, then the emanation will also have some relationship to the data. It may, therefore, be possible to reconstruct the original intelligence by analysis of these unintentional emissions.

TEMPEST equipment can essentially remotely mirror what is being done on a remote device. TEMPEST monitoring technology makes it possible for an intruder to park in a van on the street and observe exactly what a user is doing on an unprotected personal computer in a building. Emissions from a video monitor are typically in the range of 55-245 MHz, and can be received from about one kilometer away. However, the cost of TEMPEST eavesdropping equipment can vary from $5000 to $250,000, and the cost of protection against these devices varies according to the sophistication of the eavesdropper.

The goal of TEMPEST is to control stray emissions in a manner that prevents such disclosures. TEMPEST countermeasures are applied in proportion to the threat of exploitation and the risk of disclosure of the compromised information. Typical security measures include screens attached to individual machines or screened rooms in which all sensitive equipment is placed.

Thus, TEMPEST equipment is large, very expensive, and not application-specific. Detection or sniffing devices exist for the detection of specific threats, such as eavesdropping bugs, wireless networks, electronic devices, such as non-linear junction detectors, and metallic substances. However, there is currently no means to detect the mere presence of modifications to financial terminals.

### SUMMARY OF THE INVENTION

A method of detecting an unauthorized modification of a financial terminal in accordance with one form of the present invention, which incorporates some of the preferred features, includes receiving an electromagnetic profile emitted from the financial terminal, comparing the received electromagnetic profile to a stored electromagnetic profile associated with the financial terminal, and determining whether the unauthorized modification has been made to the financial terminal based on the comparison. The method may also include calculating a correlation coefficient based on the comparison and determining whether the unauthorized modification has been made to the financial terminal based on the correlation coefficient. The method may further include transmitting a stimulus profile to the financial terminal in an active mode, wherein the received electromagnetic profile is emitted by the financial terminal in response to the stimulus profile, selecting at least one of a plurality of stimulus profiles adapted to be transmitted to the financial terminal, selecting at least one of a plurality of equipment identification designators, wherein the selected equipment identification designator is associated with the financial terminal and the stored electromagnetic profile, and/or authenticating a user as a prerequisite to detecting the unauthorized modification of the financial terminal

A system adapted to detect an unauthorized modification of a financial terminal in accordance with one form of the present invention, which incorporates some of the preferred features, includes a receiver adapted to receive an electromagnetic profile emitted from the financial terminal, and a computing device operatively coupled to the receiver. The computing device is adapted to compare the received electromagnetic profile to a stored electromagnetic profile associated with the financial terminal and to determine whether the unauthorized modification has been made to the financial terminal based on the comparison. The computing device may be adapted to calculate a correlation coefficient based on the comparison and determine whether the unauthorized modification has been made to the financial terminal based on the correlation coefficient. The system may also include a transmitter adapted to transmit a stimulus profile to the financial terminal in an active mode, wherein the received electromagnetic profile is emitted by the financial terminal in response to the stimulus profile. The computing device may be adapted to select at least one of a plurality of stimulus profiles adapted to be transmitted to the financial terminal in response to user selection and to associate at least one of a plurality of equipment identification designators with the financial terminal and the stored electromagnetic profile. The system may further include an authentication device operatively coupled to the computing device, wherein the authentication device is adapted to authenticate a user as a prerequisite to detecting unauthorized modification of the financial terminal. The system may still further include at least one of serial/parallel ports, a monitor, a keyboard, a variable gain amplifier, and a tunable filter. The transmitter may include high-speed memory and an analog-to-digital converter (ADC), and the system may be adapted to be incorporated in the financial terminal

A computer-readable medium including instructions, in accordance with one form of the present invention, which incorporates some of the preferred features, wherein execution of the instructions by at least one computing device detects an unauthorized modification of a financial terminal by receiving an electromagnetic profile emitted from the financial terminal, comparing the received electromagnetic profile to a stored electromagnetic profile associated with the financial terminal, and determining whether the unauthorized modification has been made to the financial terminal based on the comparison. Execution of the instructions may also detect unauthorized modification of the financial terminal by calculating a correlation coefficient based on the comparison, determining whether the unauthorized modification has been made to the financial terminal based on the correlation coefficient, transmitting a stimulus profile to the financial terminal in an active mode, wherein the received electromagnetic profile being emitted by the financial terminal in response to the stimulus profile, selecting at least one of a plurality of stimulus profiles adapted to be transmitted to the financial terminal, and/or selecting at least one of a plurality of equipment identification designators, wherein the selected equipment identification designator is associated with the financial terminal and the stored electromagnetic profile.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a pictorial diagram of a first embodiment of a device for detecting unauthorized modifications to a financial terminal formed in accordance with the present invention in a passive mode.

FIG. 2 is a pictorial diagram of a second embodiment of the present invention for detecting unauthorized modifications to the financial terminal in an active mode.

FIG. 3 is a pictorial diagram of a third embodiment of the present invention for detecting unauthorized modifications to the financial terminal, which is incorporated into the financial terminal

FIG. 4 is a block diagram of a preferred embodiment of the device for detecting unauthorized modifications to the financial terminal in accordance with the present invention.

FIG. 5 is a flowchart of a preferred embodiment of the device for detecting unauthorized modifications to the financial terminal formed in accordance with the present invention.

### DETAILED DESCRIPTION OF THE PREFERRED EMBODIMENTS

The present in invention provides a low-cost, hand-held, reconfigurable detection device for the detection of unauthorized payment or financial terminal modifications by comparing an electromagnetic fingerprint or profile of the financial terminal to a stored reference fingerprint or profile.

The device preferably includes a radio receiver, a stimulus generator or transmitter, a computing device, which may be implemented as a microprocessor, microcontroller, application specific integrated circuit (ASIC), and/or programmable device, a storage device or memory, and a user interface.

The radio receiver may be implemented in several different technologies, including as a synthesized super heterodyne receiver, a digital signal processor (DSP), and/or software, but its function would be to identify the spectrum and modulation emitted from a target financial terminal Financial terminals are intended to include automatic teller machines (ATM), PayPass® terminals, and the like. Tuning and signal analysis are preferably performed by the computing device and the design is preferably an optimization of performance and cost using off-the-shelf parts where possible. The detection device preferably includes a variable-gain front-end and tunable filter to interface with a variety of signal strengths and interference sources encountered during use.

The stimulus transmitter is preferably implemented as a fast arbitrary waveform generator controlled by the computing device. Required stimuli are preferably downloaded to dedicated fast memory and output directly to a digital-to-analog converter. A wideband power amplifier preferably feeds a dedicated antenna system and the receiver is preferably isolated to prevent overload. The purpose of the stimulus transmitter is to excite elements of the financial terminal that are not normally radiating, such as extra cabling, circuit boards, modules, and the like.

System input/output, control, and data processing are preferably handled by the computing device, which preferably accesses electromagnetic fingerprints in a secure memory for comparison to the target financial terminal The receiver, generator, and control elements may be implemented as portions of a special-purpose microcontroller, system-on-chip (SOC), and/or reconfigurable circuit array, which would help to reduce the cost and complexity of the detection device.

The user preferably interacts with the detection device through a keyboard and monitor. A logon procedure is preferably used to protect against the detection device being accessed by unauthorized users. Fingerprint or profile downloads, software updates, and personal computer (PC) interfacing is preferably accomplished through a user port, such as a universal serial bus (USB), Ethernet interface, and/or the like. A charging interface is preferably provided for maintaining an internal battery or providing direct current (DC) power to the device.

In use, the detection device preferably detects (potentially stimulated) electromagnetic emissions from a target financial terminal and compares the resulting radio-frequency spectrum signature to a downloaded or stored reference profile, which is preferably obtained from scanning one or more uncompromised financial terminals of the same type. A correlation coefficient is preferably computed that would provide a pass/fail metric for the target financial terminal Further analysis may be performed to determine likely causes for mismatches between the received electromagnetic profile and the stored electromagnetic profile.

Thus, the device formed in accordance with the present invention essentially functions like a bug detector. Commercial terminals typically have a characteristic electromagnetic fingerprint associated with the electronics inside the terminal In military equipment, the TEMPEST specification requires the reduction of unintentional radio frequency emanations to avoid compromising secure data. In the commercial world there is little or no implementation of TEMPEST procedures largely due to their cost. Therefore, most financial terminal equipment emits radiation that is likely to compromise secure data within the equipment, such as cryptographic keys, personal identification numbers (PIN), or any information that is being processed inside the equipment and leaking through unfiltered radio channels.

Thus, all electronic equipment have a corresponding electromagnetic fingerprint. However, if the terminal is modified in some way, such as by adding a skimmer (which extracts sensitive information during a transaction), an enhanced definition monitor (ECTV), or a radio transmitter (such as a Bluetooth, global system for mobile communication (GSM), or WiFi transmitter) to the terminal to broadcast transactional data to a remote receiver in the vicinity, the terminal will have a different electromagnetic fingerprint than an unmodified terminal The device formed in accordance with the present invention is preferably a portable compact detection device or sniffer that can be pre-loaded with known electromagnetic fingerprints of original, unmodified equipment and can then be used to very quickly scan the financial terminal at the point-of-sale or transaction to see if the fingerprint of the terminal is substantially different from its expected electromagnetic profile.

The detection device is preferably a low-cost implementation of a general-purpose radio test receiver. Radio test receivers are typically very expensive and cumbersome pieces of equipment. However, the device in accordance with the present invention is preferably a hand-held device that can be loaded with the electromagnetic fingerprints or profiles of one or more known terminal types, which can then be used to perform rapid terminal site audits. In one embodiment, the detection device, if it were sufficiently inexpensive, could be used by individuals to determine whether a particular financial terminal was safe to use or not by simply performing a quick verification and waiting for some indication from the device, such as a green light, before commencing the desired transaction.

In yet another embodiment, the detection device of the present invention is functionality incorporated into the financial terminal to enable the terminal to perform a self test to determine whether unauthorized modifications have been made to the terminal The majority of terminals incorporate a secure module that stores cryptographic keys with tamper proof or tamper resistant circuitry that erases and/or overwrites cryptographic keys in response to the terminal being opened improperly, following which the terminal must be reset and enabled by the use of passwords and the like. Preferably, such a secure module would also incorporate the detection device in accordance with the present invention, which could preferably learn the correct electromagnetic fingerprint for the terminal once it was installed and configured. The built-in detection device could then perform verification processes constantly, periodically, and/or upon request. If the electromagnetic fingerprint changed, if the terminal was moved to a different location, or if it had been connected differently and had not been properly updated, then the detection device would preferably flag a possible error or problem, shut the terminal off, disable the terminal, and/or inform the host to perform further investigation.

The detection device preferably incorporates a passive mode and/or an active mode. In the passive mode, the detection device preferably receives the electromagnetic profile of the financial terminal and compares the received profile to a stored profile or fingerprint corresponding to the equipment being tested. However, in the active mode, the detection device preferably transmits an excitation or stimulus signal, such as broadband noise, receives the electromagnetic profile from the financial terminal, and compares it to the stored electromagnetic profile.

In many circumstances, the passive mode would be sufficient since there is typically enough electromagnetic radiation from financial terminals to provide an adequate fingerprint. However, if further accuracy were required, the active mode could be used to generate a broadband radio frequency noise signal that would be selectively absorbed or re-radiated depending on the particular characteristics of the financial terminal being verified. That is, wiring loops, semiconductor devices, circuits and any other components associate with the financial terminal would exhibit characteristic electromagnetic features in response to excitation by the stimulus signal. Thus, the passive mode would preferably provide a lower level of security, whereas the active mode would provide a higher or supplemental level of security.

Preferably, the excitation signal would be less than or equal to 1 GHZ, and the bandwidth of the receiver would be about 1 GHZ. The bandwidth and frequency required to receive or excite the desired electromagnetic fingerprint, profile, or signature for different types of financial terminals could be gathered by obtaining samples from representative equipment such that the user could easily distinguish unmodified equipment from compromised equipment.

The detection device formed in accordance with the present invention is intended to be used wherever financial data or account data is communicated. In addition, the detection device could be incorporated into any other type of electronic equipment, such as but not limited to a personal computer (PC), mobile phone, personal digital assistant (PDA), land-line telephone, and/or any other type of equipment from which a characteristic electromagnetic profile could be obtained.

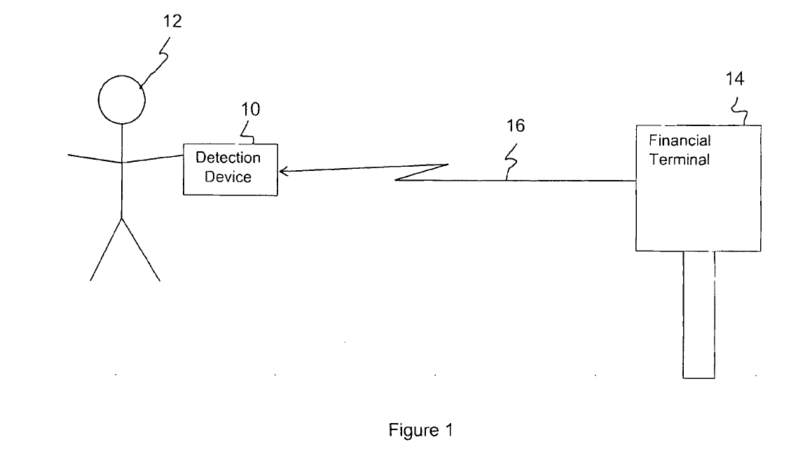

FIG. 1 shows a first embodiment of the financial terminal modification detection device 10 formed in accordance with the present invention in a passive mode. In the passive mode, a user 12 is preferably able to bring the device into proximity with a financial terminal 14, which may include but is not limited to an automated teller machine (ATM), payment terminal, and/or any other type of equipment from which a characteristic electromagnetic profile could be obtained to detect electromagnetic emissions 16 from the terminal 14 that characterize an unmodified terminal from one that has been compromised. The device 10 is preferably handheld, but may be of any size and may be moved by various alternative means known in the art while remaining within the scope of the invention.

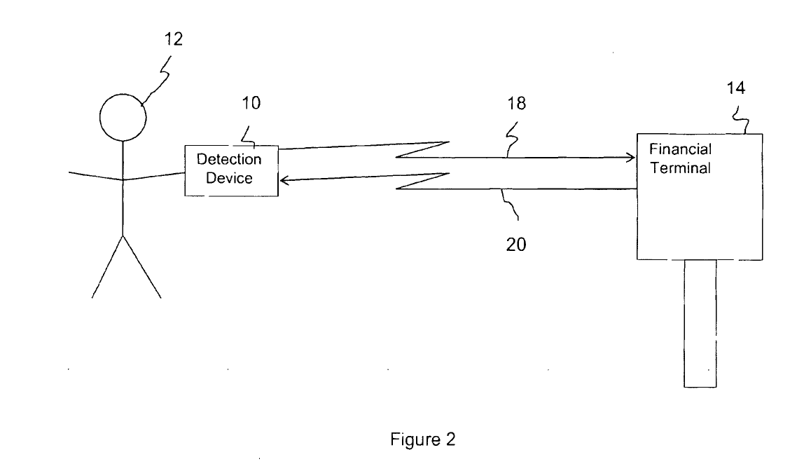

FIG. 2 shows a second embodiment of the device 10 in an active mode. In the active mode, the device 10 preferably first emits an excitation or stimulus profile or signal 18, which causes the terminal 14 to emit an electromagnetic profile or signal 20 in response thereto. The electromagnetic signal 20 effectively characterizes the terminal 14 as being with or without unauthorized modifications. It is to be understood that the detection device 10 may perform the passive and/or active modes while remaining within the scope of the present invention.

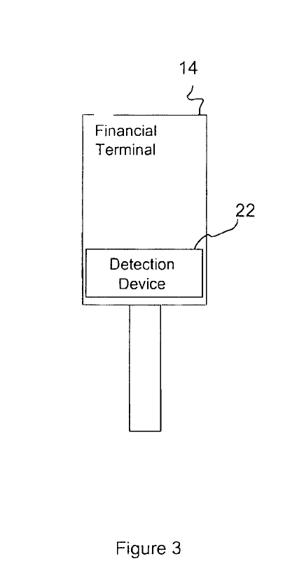

FIG. 3 shows a third embodiment of a detection device 22 formed in accordance with the present invention, which has been incorporated into the terminal 14, and is able to perform the passive and/or active modes shown in FIGS. 1 and 2 while remaining within the scope of the invention.

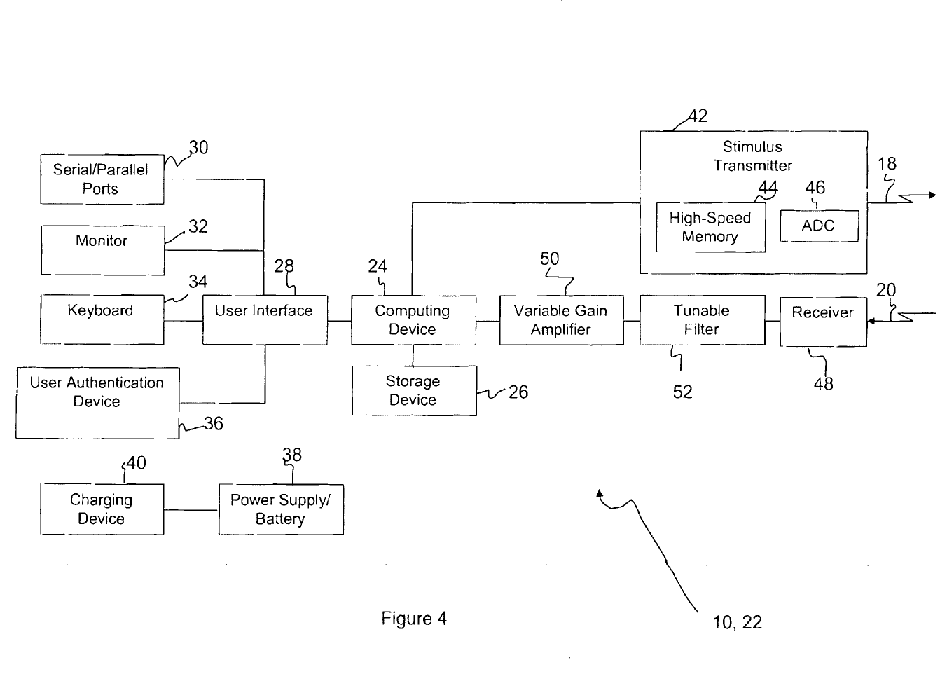

FIG. 4 shows a preferred embodiment of the device 10, 22 that include a processing device 24, such as a microprocessor, microcontroller, application specific integrated circuit (ASIC), and the like, and a storage device 26, such as non-volatile random access memory (NVRAM), read only memory (ROM), Flash, electrically erasable programmable read only memory (EEPROM), electrically programmable read only memory (EPROM), and the like electrically coupled thereto. The processing device 24 is preferably electrically coupled to a user interface 28, which enables the processing device 24 to communicate with serial/parallel ports 30, a monitor 32, a keyboard 34, and a user authentication device 36. The serial/parallel ports 30 preferably enable the upload or download of electromagnetic signatures or profiles corresponding to each of the financial terminals to be tested. The monitor 32 and keyboard 34 enable the user to interface with the device 10, 22. The user authentication device 36 preferably enables the input of biometric data, such as fingerprint in order to authenticate the user and enable operation of the device 10, 22 for a particular user.

The device 10 also preferably includes a power supply or battery 38 operatively coupled to a charging interface 40, which supplies power to the device 10, 22 as either an alternating current (AC) signal and/or battery supplied direct current (DC) signal. The excitation or stimulus signal 18 shown in FIGS. 1 and 2 is preferably provided by a stimulus generator or transmitter 42, which may include a dedicated high-speed memory 44 and an analog-to-digital converter (ADC) 46 operatively coupled to the processing device 24 to enable the high-speed generation of arbitrary waveforms.

The electromagnetic profile 20 is preferably received by a receiver 48, which is operatively coupled to the computing device 24 through a variable gain amplifier 50 and a tunable filter 52. The amplifier 50 and filter 52 are operatively coupled to the processing device 24 to enable selection of gain and/or filter parameters by the computing device 24

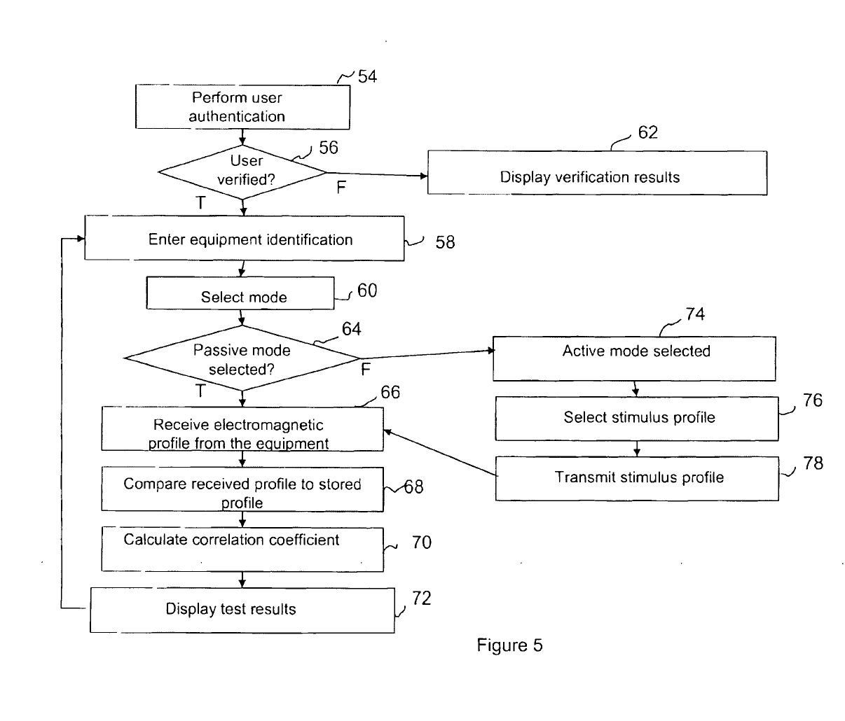

FIG. 5 is a flowchart of a preferred embodiment of processes performed by the detection device 10, 22 in accordance with the present invention. User authentication is preferably performed in step 54 and, if the particular user is verified as being authentic in step 56, the user is prompted to enter an identification designator associated with the equipment to be tested in step 58. The user is then given the option of selecting a mode in step 60. If the user is not verified in step 56, the results of the verification are preferably displayed in step 62.

If the passive mode is selected in step 64, the device preferably receives an electromagnetic profile from the equipment to be tested in step 66 and compares the received electromagnetic profile with the stored electromagnetic profile corresponding to the equipment selected to be tested in step 68. The device then preferably computes a correlation coefficient in step 70 to determine whether the equipment being tested is sufficiently within an acceptable tolerance to establish that no unauthorized modifications have been made to the equipment. The test results are then preferably displayed in step 72.

If the passive mode is not selected in step 64, then the active mode is selected in step 74 and the user is prompted to select a stimulus or excitation profile in step 76. The selected stimulus profile is then transmitted in step 78, and the electromagnetic profile emitted by the equipment under test is received by the detection device in step 66. The detection device then preferably compares the received electromagnetic profile to the stored electromagnetic profile in step 68 and computes the correlation coefficient in step 70 to determine whether the equipment under test has successfully passed the test as being uncompromised. The test results are then preferably displayed in step 72. The process preferably returns to prompt the user to enter the identification designator associated with another piece of equipment to be tested in step 58.

Although preferred embodiments of the present invention have been described herein with reference to the accompanying drawings, it is to be understood that the invention is not limited to those precise embodiments and that various other changes and modifications may be affected herein by one skilled in the art without departing from the scope or spirit of the invention, and that it is intended to claim all such changes and modifications that fall within the scope of the invention.

What is claimed is:

1. A method of detecting an unauthorized modification of a financial terminal comprising:
receiving an electromagnetic profile emitted from the financial terminal;
comparing the received electromagnetic profile to a stored electromagnetic profile associated with the financial terminal; and
determining whether the unauthorized modification has been made to the financial terminal based on the comparison.

2. A method of detecting an unauthorized modification of a financial terminal defined by claim 1, further comprising:
calculating a correlation coefficient based on the comparison; and
determining whether the unauthorized modification has been made to the financial terminal based on the correlation coefficient.

3. A method of detecting an unauthorized modification of a financial terminal defined by claim 1, further comprising transmitting a stimulus profile to the financial terminal in an active mode, the received electromagnetic profile being emitted by the financial terminal in response to the stimulus profile.

4. A method of detecting an unauthorized modification of a financial terminal defined by claim 3, further comprising selecting at least one of a plurality of stimulus profiles adapted to be transmitted to the financial terminal

5. A method of detecting an unauthorized modification of a financial terminal defined by claim 1, further comprising selecting at least one of a plurality of equipment identification designators, the selected equipment identification designator being associated with the financial terminal and the stored electromagnetic profile.

6. A method of detecting an unauthorized modification of a financial terminal defined by claim 1, further comprising authenticating a user as a prerequisite to detecting the unauthorized modification of the financial terminal

7. A system adapted to detect an unauthorized modification of a financial terminal comprising:
a receiver adapted to receive an electromagnetic profile emitted from the financial terminal; and
a computing device operatively coupled to the receiver, the computing device being adapted to compare the received electromagnetic profile to a stored electromagnetic profile associated with the financial terminal, the computing device being adapted to determine whether the unauthorized modification has been made to the financial terminal based on the comparison.

8. A system adapted to detect an unauthorized modification of a financial terminal defined by claim 7, wherein the computing device is adapted to calculate a correlation coefficient based on the comparison, the computing device being adapted to determine whether the unauthorized modification has been made to the financial terminal based on the correlation coefficient.

9. A system adapted to detect an unauthorized modification of a financial terminal defined by claim 7, further comprising a transmitter adapted to transmit a stimulus profile to the financial terminal in an active mode, the received electromagnetic profile being emitted by the financial terminal in response to the stimulus profile.

10. A system adapted to detect an unauthorized modification of a financial terminal defined by claim 9, wherein the computing device is adapted to select at least one of a plurality of stimulus profiles adapted to be transmitted to the financial terminal in response to user selection.

11. A system adapted to detect an unauthorized modification of a financial terminal defined by claim 7, wherein the computing device is adapted to associate at least one of a plurality of equipment identification designators with the financial terminal and the stored electromagnetic profile.

12. A system adapted to detect an unauthorized modification of a financial terminal defined by claim 7, further comprising an authentication device operatively coupled to the computing device, the authentication device being adapted to authenticate a user as a prerequisite to detecting the unauthorized modification of the financial terminal.

13. A system adapted to detect an unauthorized modification of a financial terminal defined by claim 7, further comprising at least one of serial/parallel ports, a monitor, keyboard, variable gain amplifier, and tunable filter.

14. A system adapted to detect an unauthorized modification of a financial terminal defined by claim 7, wherein the transmitter comprises high-speed memory and an analog-to-digital converter (ADC).

15. A system adapted to detect an unauthorized modification of a financial terminal defined by claim 7, wherein the system is adapted to be incorporated in the financial terminal

16. A computer-readable medium comprising instructions, wherein execution of the instructions by at least one computing device detects an unauthorized modification of a financial terminal by:
receiving an electromagnetic profile emitted from the financial terminal;
comparing the received electromagnetic profile to a stored electromagnetic profile associated with the financial terminal; and
determining whether the unauthorized modification has been made to the financial terminal based on the comparison.

17. A computer-readable medium comprising instructions defined by claim 16, wherein execution of the instructions by at least one computing device detects an unauthorized modification of a financial terminal by:
calculating a correlation coefficient based on the comparison; and
determining whether the unauthorized modification has been made to the financial terminal based on the correlation coefficient.

18. A computer-readable medium comprising instructions defined by claim 16, wherein execution of the instructions by at least one computing device detects an unauthorized modification of a financial terminal by transmitting a stimulus profile to the financial terminal in an active mode, the received electromagnetic profile being emitted by the financial terminal in response to the stimulus profile.

19. A computer-readable medium comprising instructions defined by claim 18, wherein execution of the instructions by at least one computing device detects an unauthorized modification of a financial terminal by selecting at least one of a plurality of stimulus profiles adapted to be transmitted to the financial terminal

20. A computer-readable medium comprising instructions defined by claim 16, wherein execution of the instructions by at least one computing device detects an unauthorized modification of a financial terminal by selecting at least one of a plurality of equipment identification designators, the selected equipment identification designator being associated with the financial terminal and the stored electromagnetic profile.
